(19) United States
(12) Patent Application Publication
(10) Pub. No.: US 2013/0255091 A1
(43) Pub. Date: Oct. 3, 2013

(54) MACHINING APPARATUS WITH ON-MACHINE MEASURING FUNCTION

(71) Applicant: TOSHIBA KIKAI KABUSHIKI KAISHA, Tokyo-to (JP)

(72) Inventors: Masahiko FUKUTA, Numazu-shi (JP); Katsuji GAKUHARI, Numazu-shi (JP)

(73) Assignee: TOSHIBA KIKAI KABUSHIKI KAISHA, Tokyo-to (JP)

(21) Appl. No.: 13/797,238

(22) Filed: Mar. 12, 2013

(30) Foreign Application Priority Data
Mar. 13, 2012 (JP) 2012-056273
Feb. 15, 2013 (JP) 2013-027935

(51) Int. Cl. G01B 5/008

(52) U.S. Cl. CPC G01B 5/008
USPC 33/503

(57) ABSTRACT

A machining apparatus including a distributor which generates a movement command for a motor; a position detector which detects a working position of the motor; and a motor controller which controls a corresponding motor based on the movement command, with the output of the position detector being fedback to the motor controller. During a scanning measurement control, in place of a machining tool, a probe sensor capable of measuring a distance relative to a work is attached, and while input of the movement command to the motor controller is interrupted, a measurement result obtained by the probe sensor is fedback to the motor controller. The detection result obtained by the position detector is superimposed on the measurement result and outputted as information on a shape of the work.

### CROSS REFERENCE TO RELATED APPLICATIONS

This application is based upon and claims the benefit of priority from the prior Japanese Patent Application No. 2012-056273 filed on Mar. 13, 2012 and No. 2013-027935 filed on Feb. 15, 2013. The entire contents of which are incorporated herein by reference.

### TECHNICAL FIELD

The present invention relates to a machining apparatus having a function for measuring a shape of a work by a scanning (copying, profiling) action.

### BACKGROUND ART

It has been conventionally known to measure a shape of a work with high precision, by moving a probe along the shape of the work (by scanning the shape of the work with a probe).

A conventional scanning control employs a principle in which, while a movement path of a probe is actively controlled such that the movement path corresponds to an already obtained design value of a work, a displacement of the probe that occurs during the active movement control is passively measured, so as to measure an actual “deviation” from the work design value.

Thus, a mechanism for passively measuring a displacement of the probe is needed in theory. Such a mechanism is generally referred to as “scaler” or the like.

For example, WO00/52419 discloses an NC machining apparatus employing a stylus-type probe head. In this apparatus, by carrying out a scanning control by which contact between the probe head and a work is maintained to continuously acquire a displacement of a contactor of the probe head, a shape of the work can be measured with high precision. In particular, this apparatus uses a laser interferometer In the measurement of a displacement of the contactor, thereby achieving a highly precise scanning measurement of the work.

### SUMMARY OF THE INVENTION

However, to equip a machining apparatus with a scaler exclusively (independently) used for the scanning control is disadvantageous in terms of costs and an installation space.

The present invention has been made in view of the above circumstances. The object of the present invention is to provide a machining apparatus that can realize a scanning measurement control at low costs, without provision of a scaler exclusively used for the scanning control.

The present invention is a machining apparatus comprising: a distributor configured to generate a movement command for a motor; a position detector configured to detect a working position of the motor; and a motor controller configured to control a corresponding motor based on the movement command, with a detection result obtained by the position detector being fedback to the motor controller in order that the detection result obtained by the position detector corresponds to a predetermined working position; wherein: during a scanning measurement control, in place of a machining tool, a probe sensor capable of measuring a distance relative to a work is attached; during the scanning measurement control, input of the movement command to the motor controller is interrupted, and a measurement result obtained by the probe sensor is fedback to the motor controller in order that the measurement result obtained by the probe sensor corresponds to a predetermined distance; and during the scanning measurement control, information in which the detection result obtained by the position detector and the measurement result obtained by the probe sensor are superimposed on each other, is outputted as information on a shape of the work.

According to the present Invention, since the position detector configured to detect a working position of the motor can be used as a scaler in principle during the scanning measurement control, the scanning measurement control can be carried out without provision of a scaler exclusively used for the scanning measurement control. Thus, the present invention is significantly advantageous in terms of costs and an Installation space, The novel idea that a movement command to the motor controller is interrupted during the scanning measurement control has enabled such a structure.

To be specific, for example, the motor is a Y-axis motor; the position detector is configured to detect a working position of the Y-axis motor; the motor controller is configured to control the corresponding Y-axis motor based on a movement command for the Y-axis motor, with a detection result obtained by the position detector-being fedback to the motor controller in order that the detection result obtained by the position detector corresponds to a predetermined working position; and during the scanning measurement control, Input of the movement command for the Y-axis motor to the motor controller Is interrupted, and a measurement result obtained by the probe sensor is fedback to the motor controller in order that the measurement result obtained by the probe sensor corresponds to a predetermined distance. In this case, the scanning measurement control is carried out by continuously moving the probe sensor in an X-axis direction and/or a Y-axis direction.

The present invention is particularly effective when applied to a machining apparatus for machining a microlens array or a machining apparatus for machining a mold (metal mold) for forming a microlens array. Since a microlens array or a mold for forming a microlens array is likely to have a large error during machining, it has been necessary to enlarge a stroke of a scaler for the scanning measurement control. In contrast thereto, according to the present invention, a scaler exclusively used for the scanning measurement control is not needed, and a machining error range which can be measured (handled) is not limited in theory.

Various types of conventionally known probe sensors may be used as the probe sensor of this invention. For example, in a machining apparatus for machining a microlens array or a mold for forming a microlens array, the machining apparatus of a type including a measuring mechanism using a He—Ne laser is preferred in terms of measurement precision.

In addition, preferably, the machining apparatus of the present invention further includes a machining correction unit configured to correct machining data or a machining program, based on the outputted information on the shape of the work. By applying the highly precise information on the shape of the work to the correction of machining data or a machining program, machining precision can be enhanced.

Alternatively, the present invention is a method of carrying out a scanning measurement control of a work with the use of a machining apparatus comprising a distributor configured to generate a movement command for a motor, a position detector configured to detect a working position of the motor, and a motor controller configured to control a corresponding motor based on the movement command, with a detection result obtained by the position detector being fedback to the motor controller in order that the detection result obtained by the position detector corresponds to a predetermined working position, the method comprising: attaching, in place of a machining tool, a probe sensor capable of measuring a distance relative to a work; while interrupting input of the movement command to the motor controller, feedbacking a measurement result obtained by the probe sensor to the motor controller in order that the measurement result obtained by the probe sensor corresponds to a predetermined distance; and outputting, as information on a shape of the work, information In which the detection result obtained by the position detector and the measurement result obtained by the probe sensor are superimposed on each other.

To be specific, for example, the motor is a Y-axis motor; the position detector is configured to detect a working position of the Y-axis motor; the motor controller is configured to control the corresponding Y-axis motor based on a movement command for the Y-axis motor, with a detection result obtained by the position detector being feedback to the motor controller in order that the detection result obtained by the position detector corresponds to a predetermined working position; and the interrupted input of the movement command to the motor control is a movement command for the Y-axis motor, and the measurement result by the probe sensor is fedback to the motor controller in order that the measurement result by the probe sensor corresponds to a predetermined distance, while a relative movement in an X-axis direction and/or a Z-axis direction are continued.

### BRIEF DESCRIPTION OF THE DRAWINGS

FIG. 1 Is a schematic block diagram of a machining apparatus in one embodiment of the present invention;

FIG. 2 is a schematic view for explaining how a probe sensor follows a work;

FIG. 3 is a graph showing a corrected machining result based on a measurement result of a work shape; and

FIG. 4 is a graph showing another corrected machining result based on a measurement result of a work shape.

### BEST MODE FOR CARRYING OUT THE INVENTION

An embodiment of the present invention will be described herebelow in detail, with reference to the attached drawings.

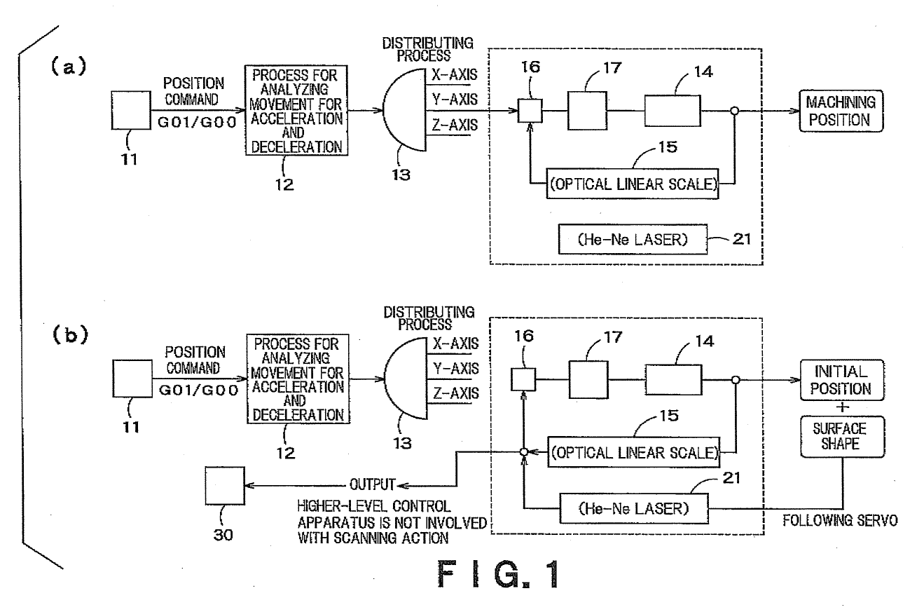

FIGS. 1(a) and 1(b) are schematic block diagrams of a machining apparatus in one embodiment of the present invention. The machining apparatus 10 in this embodiment Includes: a position commanding unit 11 configured to generate a position command (e.g., G01/G00); a unit for analyzing movement for acceleration and deceleration 12 in which a process for analyzing movement for acceleration and deceleration is performed; and a distributor (distributing unit) 13 configured to generate a movement command for each motor corresponding to each of an X axis (X feed axis), a Y axis (Y feed axis) and a Z axis (Z feed axis). In this embodiment, each motor is a rotary motor.

The motor 14 corresponding to each axis Is provided with a position detector 15 configured to detect a rotated position of the motor 14. The position detector 15 in this embodiment is formed of an optical linear scale. During a machining control, a machining tool attached for a desired machining process is relatively moved by the motors 14 of the respective axes.

In addition, there is disposed a motor controller 16 configured to control the corresponding motor 14 based on a movement command from the distributor 13, with a detection result obtained by the position detector 15 being fedback to the motor controller 16 in order that the detection result obtained by the position detector 15 corresponds to a predetermined rotated position. In this embodiment, an amplifier 17 is disposed between the motor controller 16 and the motor 14.

During the machining control, the machining apparatus 10 in this embodiment operates as shown in FIG. 1(a). Namely, based on a position command from the position commanding unit 11, a process for analyzing movement for acceleration and deceleration is performed by the unit for analyzing movement for acceleration and deceleration 12, and the distributor 13 generates movement commands to the respective motors 14 corresponding to the X axis, the Y axis and the Z axis, respectively.

Then, in addition to the movement command from the distributor 13, the corresponding motor 14 is controlled by the motor controller 16, with a detection result obtained by the position detector 15 being fedback to the motor controller 16 in order that the detection result obtained by the position detector 15 corresponds to a predetermined rotated position. In this manner, machining of a work by the machining tool is realized.

The essential feature of the present invention resides, not in the machining control, but in a scanning measurement control, That is to say, during the scanning measurement control, in place of the machining tool, a probe sensor 21 capable of measuring a distance relative to the work is attached to the machining apparatus 10 in this embodiment.

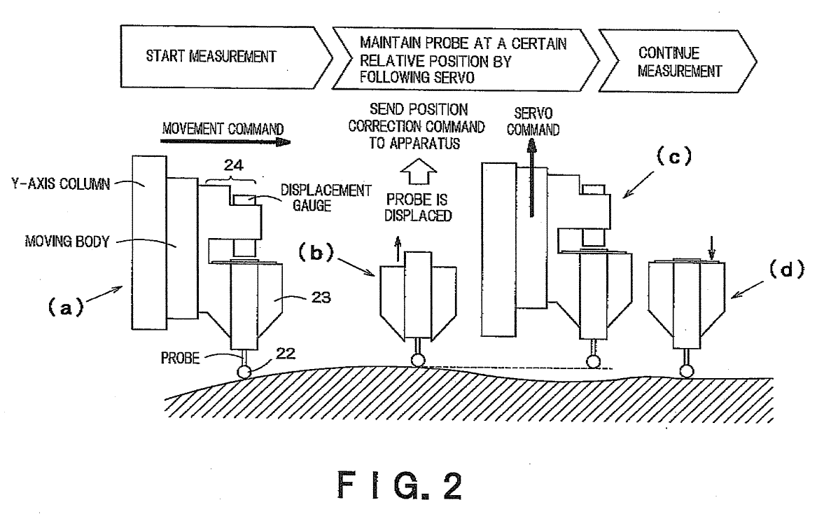

The probe sensor 21 in this embodiment includes: a contactor 22 configured to maintain contact with a work; a pneumatic bearing 23 configured to support the contactor 22 such that the contactor 22 can be displaced; and a head part 24 capable of measuring a displacement quantity of the contactor 22 (see FIG. 2). The head part 24 has a laser interferomatric displacement gauge of an optical fiber type using a He—Ne laser, thereby achieving a resolution as high as 0.038 nm. In addition, the pneumatic bearing 23 (also referred to as “air slider”) achieves a measurement force as low as about 50 mgf.

As shown in FIG. 1(b), during the scanning measurement control, while input of a movement command to the motor controller 16 is interrupted (a movement command is used until the probe sensor 21 is moved to an initial position), a measurement result obtained by the probe sensor 21 is fedback to the motor controller 16 in order that the measurement result obtained by the probe sensor 21 corresponds to a predetermined distance. Namely, information in which the detection result obtained by the position detector 15 and the measurement result obtained by the probe sensor 21 are superimposed on each other, is outputted as information on a shape of the work.

With reference to FIG. 2, how the probe sensor 21 follows the work is explained. FIG. 2 shows that, when the probe sensor 21 is moved relatively to the work in an X-axis direction and/or a Z-axis direction (movement in the X-axis direction and/or the Z-axis direction is carried out based on a movement command), the work shape (concavity and convexity, irregularities) In a Y-axis direction is measured (a movement command in the Y-axis direction is interrupted).

As shown in FIG. 2, when the work convexly curves upward during the relative movement (FIG. 2(a) FIG. 2(b)), a movement path of an end (contactor 22 in this case) of the probe sensor 21 follows the shape. Namely, the end of the probe sensor 21 is displaced upward (FIG. 2(b)). Immediately, the displacement information is fedback to the motor controller 16, and the motor corresponding to the Y-axis receives a feedback command. As a result, the entire position of the probe sensor 21 is corrected upward, so that the end (contactor 22 in this case) of the probe sensor 21 returns immediately to a neutral condition. Meanwhile, when the end of the probe sensor 21 moves away from the work (FIG. 2(c)), the entire position of the probe sensor 21 is corrected downward, so that the end of the probe sensor 21 comes again into contact with the work (FIG. 2 (d)).

At this time, information in which the rotated position of the motor detected by the position detector 15 and the end position (remaining displacement quantity) of the probe sensor 21 are superimposed on each other, is outputted as information on a shape of the work at the point of FIG. 2(b)=FIG. 2(c). Namely, since a movement command in the Y-axis direction is interrupted, the position detector 15 can be used as a scaler for measuring a displacement.

As described above, according to this embodiment, since the position detector 15 configured to detect a rotated position of the motor 14 can be used as a scaler in theory during the scanning measurement control, the scanning measurement control can be carried out without provision of a scaler exclusively used for the scanning measurement control. Thus, the present Invention is significantly effective in terms of costs and an installation space. In addition, since the probe sensor 21 is feedback-controlled such that the probe sensor 21 always returns to the neutral condition, it rarely occurs that the probe sensor 21 is largely displaced. In the conventional method, since the measurement of the displacement quantity relative to a certain standard (e.g., a design value) is continuously carried out, there is a case in which the displacement of the probe sensor 21 becomes large, which results in poor measurement precision. However, according to this embodiment, such a problem can be solved.

Furthermore, according to this embodiment, since the scanning measurement control is carried out in the machining apparatus itself, it is unnecessary to detach a work therefrom, in contrast to a conventional case In which a work-shape measuring device is additionally utilized outside the machining apparatus. Thus, an operating efficiency can be remarkably improved. When shape data of the measured work are used for generating corrected machining data or a corrected machining program, this effect becomes more noticeable. For example, a machining correction unit 30 corrects, based on shape data of a measured work (work-shape Information), machining data or a machining program so as to generate corrected machining data or a corrected machining program. Thus, machining precision can be enhanced.

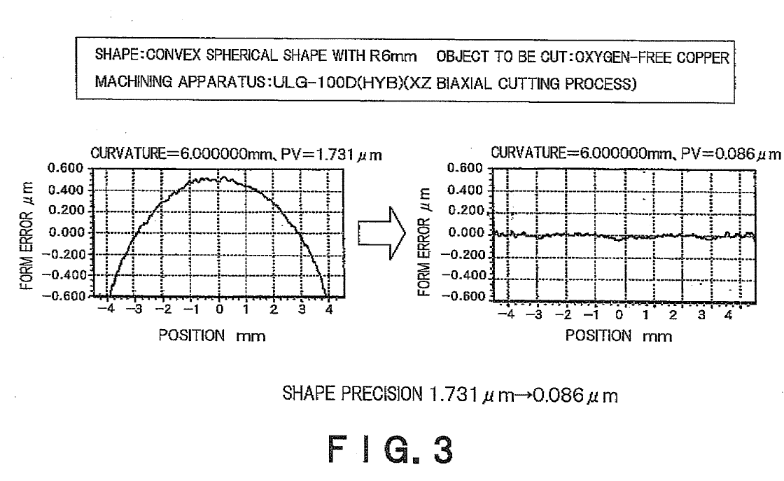

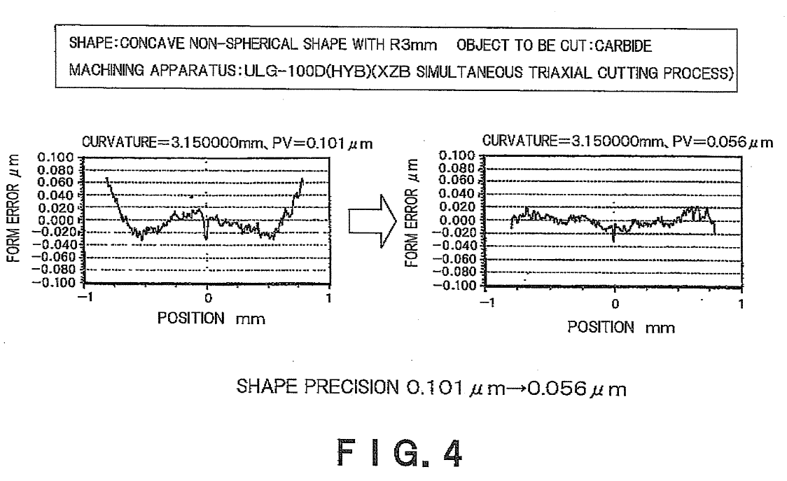

FIGS. 3 and 4 respectively show concrete results of experiments conducted as follows. A microlens array or a mold for forming a microlens array was machined by means of the machining apparatus according to this embodiment, and then shape data were obtained by the scanning measurement control. Thereafter, a machining program was corrected based on the shape data, and then the microlens array or the mold for forming a microlens array was again machined and subjected to the scanning measurement control. As shown in FIGS. 3 and 4, when the work shape data can be measured with high precision, a remarkably effective machining program correction can be achieved.

Although the respective motors 14 are rotary motors in the above embodiment, the motors 14 may be linear motors. In this case, the position detector 15 is configured to detect a moved position of the linear motor.

1. A machining apparatus comprising:
a distributor configured to generate a movement command for a motor;
a position detector configured to detect a working position of the motor; and
a motor controller configured to control a corresponding motor based on the movement command, with a detection result obtained by the position detector being fedback to the motor controller in order that the detection result obtained by the position detector corresponds to a predetermined working position;
wherein:
during a scanning measurement control, in place of a machining tool, a probe sensor capable of measuring a distance relative to a work is attached;
during the scanning measurement control, input of the movement command to the motor controller is interrupted, and a measurement result obtained by the probe sensor is fedback to the motor controller in order that the measurement result obtained by the probe sensor corresponds to a predetermined distance; and
during the scanning measurement control, information In which the detection result obtained by the position detector and the measurement result obtained by the probe sensor are superimposed on each other, is outputted as information on a shape of the work.

2. The machining apparatus according to claim 1, wherein
the motor is a Y-axis motor;
the position detector is configured to detect a working position of the Y-axis motor;
the motor controller is configured to control the corresponding Y-axis motor based on a movement command for the Y-axis motor, with a detection result obtained by the position detector being fedback to the motor controller in order that the detection result obtained by the position detector corresponds to a predetermined working position; and
during the scanning measurement control, input of the movement command for the Y-axis motor to the motor controller is interrupted, and a measurement result obtained by the probe sensor is fedback to the motor controller in order that the measurement result obtained by the probe sensor corresponds to a predetermined distance.

3. The machining apparatus according to claim 2, wherein
the scanning measurement control is carried out by continuously moving the probe sensor in an X-axis direction and/or a Y-axis direction.

4. The machining apparatus according to claim 1, wherein
the work is a microlens array.

5. The machining apparatus according to claim 1, wherein
the work is a mold for forming a microlens array.

6. The machining apparatus according to claim 1, wherein
the probe sensor includes a measuring mechanism using a He—Ne laser.

7. The machining apparatus according to claim 1, further comprising a machining correction unit configured to correct machining data or a machining program, based on the outputted information on the shape of the work.

8. A method of carrying out a scanning measurement control of a work with the use of a machining apparatus comprising a distributor configured to generate a movement command for a motor, a position detector configured to detect a working position of the motor, and a motor controller configured to control a corresponding motor based on the movement command, with a detection result obtained by the position detector being fedback to the motor controller in order that the detection result obtained by the position detector corresponds to a predetermined working position, the method comprising:
attaching, in place of a machining tool, a probe sensor capable of measuring a distance relative to a work;
while interrupting input of the movement command to the motor controller, feedbacking a measurement result obtained by the probe sensor to the motor controller in order that the measurement result obtained by the probe sensor corresponds to a predetermined distance; and
outputting, as information on a shape of the work, information in which the detection result obtained by the position detector and the measurement result obtained by the probe sensor are superimposed on each other.

9. The method according to claim 8, wherein
the motor is a Y-axis motor;
the position detector is configured to detect a working position of the Y-axis motor;
the motor controller is configured to control the corresponding Y-axis motor based on a movement command for the Y-axis motor, with a detection result obtained by the position detector being fedback to the motor controller in order that the detection result obtained by the position detector corresponds to a predetermined working position; and
the interrupted input of the movement command to the motor control is a movement command for the Y-axis motor, and the measurement result by the probe sensor is fedback to the motor controller in order that the measurement result by the probe sensor corresponds to a predetermined distance, while a relative movement in an X-axis direction and/or a Z-axis direction are continued.
